(19) United States
(12) Patent Application Publication
(10) Pub. No.: US 2025/0390290 A1
(43) Pub. Date: Dec. 25, 2025

(54) ESTIMATION BASED JUST-IN-TIME COMPILING

(71) Applicant: SAP SE, Walldorf (DE)

(72) Inventors: Jan Siebert, Heidelberg (DE); Manuel Mayr, Walldorf (DE); Till Merker, Sandhausen (DE)

(21) Appl. No.: 18/732,155

(22) Filed: Jun. 3, 2024

(51) Int. Cl. G06F 8/41

(52) U.S. Cl. CPC G06F 8/41

(57) ABSTRACT

Arrangements for estimation based just-in-time compiling are provided. First and second thresholds may be set by selecting a value of a corresponding cardinality flag. One or more cardinality estimates may be received for each operator of a query, including input, output, and intermediate estimated cardinalities. For each operator, a highest value of the one or more cardinality estimates may be determined. Based on the highest value being less than or equal to the first threshold, the query may be processed initially by an interpreter and subsequently by a compiler. Based on the highest value being between the first and second thresholds, the query may be processed by both by the compiler and the interpreter at the start. Based on the highest value being greater than or equal to the second threshold, the query may be processed initially by the compiler and use of the interpreter may be avoided.

### TECHNICAL FIELD

The subject matter described herein relates generally to data processing and more specifically to estimation based just-in-time (JIT) compiling.

### BACKGROUND

A database execution engine may operate on operators that generate a type of processing code known as “L-code” that can be either compiled or interpreted. In conventional compilation strategies, global configurations are made applicable for all queries and all workloads in a system. The compiling decision is made for all operators simultaneously, with policies being universally applicable to each operator. It may be desired to have a more granular execution strategy, focusing on each operator individually in order to enable more efficient utilization of database systems.

### SUMMARY

Methods, systems, and articles of manufacture, including computer program products, are provided for estimation based just-in-time compiling. In one aspect, there is provided a system including at least one processor and at least one memory. The at least one memory can store instructions that cause operations when executed by the at least one processor. The operations may include: setting, from a user interface, a first threshold by selecting a value of a first cardinality flag; setting, from the user interface, a second threshold by selecting a value of a second cardinality flag, the second threshold being greater than the first threshold; receiving, from an optimizer, one or more cardinality estimates for each operator of a query; determining a highest value of the one or more cardinality estimates for each operator of the query; and selecting, based on the highest value of the one or more cardinality estimates for each operator of the query, one of at least three processing modes for processing the query. The at least three processing modes may include a first mode, a second mode, and a third mode. Based on the highest value being less than or equal to the first threshold, indicating the first mode, the operations may include commencing processing of the query by interpreting source code and initiating compiling of the source code asynchronously. Based on the highest value being between the first threshold and the second threshold, indicating the second mode, the operations may include commencing processing of the query by both compiling and interpreting the source code. Based on the highest value being greater than or equal to the second threshold, indicating the third mode, the operations may include commencing processing of the query by compiling the source code and avoiding use of an interpreter.

In some variations, one or more of the features disclosed herein including the following features can optionally be included in any feasible combination. In some variations, the one or more cardinality estimates may include one or more of: an estimated input cardinality, an estimated output cardinality, and an estimated intermediate cardinality.

In some variations, initiating compiling of the source code asynchronously may include initiating the compiling after executing the interpreting a predetermined number of times, and switching the processing to compiled code.

In some variations, the operations may further include, in the second mode, switching the processing to compiled code when the compiled code is available.

In some variations, the operations may further include overriding the selected processing mode by triggering compilation earlier than specified by the selected processing mode.

In some variations, the first threshold and the second threshold may be based on benchmark data associated with a workload.

In some variations, the first threshold and the second threshold may be set at a tenant database level.

In some variations, the estimated intermediate cardinality may include an estimate indicating a number of result tuples of a join operator.

In another aspect, there is provided a method for estimation based just-in-time compiling. The method may include: setting, from a user interface, a first threshold by selecting a value of a first cardinality flag; setting, from the user interface, a second threshold by selecting a value of a second cardinality flag, the second threshold being greater than the first threshold; receiving, from an optimizer, one or more cardinality estimates for each operator of a query; determining a highest value of the one or more cardinality estimates for each operator of the query; and selecting, based on the highest value of the one or more cardinality estimates for each operator of the query, one of at least three processing modes for processing the query. The at least three processing modes may include a first mode, a second mode, and a third mode. Based on the highest value being less than or equal to the first threshold, indicating the first mode, the method may include commencing processing of the query by interpreting source code and initiating compiling of the source code asynchronously. Based on the highest value being between the first threshold and the second threshold, indicating the second mode, the method may include commencing processing of the query by both compiling and interpreting the source code. Based on the highest value being greater than or equal to the second threshold, indicating the third mode, the method may include commencing processing of the query by compiling the source code and avoiding use of an interpreter.

In some variations, one or more of the features disclosed herein including the following features can optionally be included in any feasible combination. In some variations, the one or more cardinality estimates may include one or more of: an estimated input cardinality, an estimated output cardinality, and an estimated intermediate cardinality.

In some variations, initiating compiling of the source code asynchronously may include initiating the compiling after executing the interpreting a predetermined number of times, and switching the processing to compiled code.

In some variations, the method may further include, in the second mode, switching the processing to compiled code when the compiled code is available.

In some variations, the method may further include overriding the selected processing mode by triggering compilation earlier than specified by the selected processing mode.

In some variations, the first threshold and the second threshold may be based on benchmark data associated with a workload.

In some variations, the first threshold and the second threshold may be set at a tenant database level.

In some variations, the estimated intermediate cardinality may include an estimate indicating a number of result tuples of a join operator.

In another aspect, there is provided a computer program product that includes a non-transitory computer readable medium. The non-transitory computer readable medium may store instructions that cause operations when executed by at least one processor. The operations may include: setting, from a user interface, a first threshold by selecting a value of a first cardinality flag; setting, from the user interface, a second threshold by selecting a value of a second cardinality flag, the second threshold being greater than the first threshold; receiving, from an optimizer, one or more cardinality estimates for each operator of a query; determining a highest value of the one or more cardinality estimates for each operator of the query; and selecting, based on the highest value of the one or more cardinality estimates for each operator of the query, one of at least three processing modes for processing the query. The at least three processing modes may include a first mode, a second mode, and a third mode. Based on the highest value being less than or equal to the first threshold, indicating the first mode, the operations may include commencing processing of the query by interpreting source code and initiating compiling of the source code asynchronously. Based on the highest value being between the first threshold and the second threshold, indicating the second mode, the operations may include commencing processing of the query by both compiling and interpreting the source code. Based on the highest value being greater than or equal to the second threshold, indicating the third mode, the operations may include commencing processing of the query by compiling the source code and avoiding use of an interpreter.

In some variations, one or more of the features disclosed herein including the following features can optionally be included in any feasible combination. In some variations, the one or more cardinality estimates may include one or more of: an estimated input cardinality, an estimated output cardinality, and an estimated intermediate cardinality.

In some variations, initiating compiling of the source code asynchronously may include initiating the compiling after executing the interpreting a predetermined number of times, and switching the processing to compiled code.

In some variations, the operations may further include, in the second mode, switching the processing to compiled code when the compiled code is available.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an illustrative computing environment for estimation based just-in-time compiling in accordance with some example embodiments;

FIG. 2 depicts a flowchart illustrating a process for estimation based just-in-time compiling in accordance with some example embodiments;

FIG. 3 depicts a diagram illustrating predetermined thresholds for estimation based just-in-time compiling in accordance with some example embodiments; and

FIG. 4 depicts a block diagram illustrating a computing system, in accordance with some example embodiments.

When practical, similar reference numbers denote similar structures, features, or elements.

### DETAILED DESCRIPTION

Aspects of the disclosure provide a technical solution that addresses problems associated with estimation based just-in-time (JIT) compiling (also referred to as “jitting”). Aspects of the disclosure provide for a sophisticated an adaptive compilation technique that allows compiles on a per-operator basis, rather than as a batch, utilizing estimated cardinalities. For example, aspects of the disclosure utilize estimated cardinalities for each operator of a query in making decisions on whether or not to compile. Because each operator is focused on individually, some operators might be compiled while others might not. Furthermore, thresholds may be set and tailored according to different estimation-based compilation strategies. Advantageously, a system may intelligently make compilation decisions, attuning performance to specific workload characteristics. Consequently, optimal latency and execution speed may be attained while minimizing the usage of resources. These and various other arrangements will be discussed more fully below.

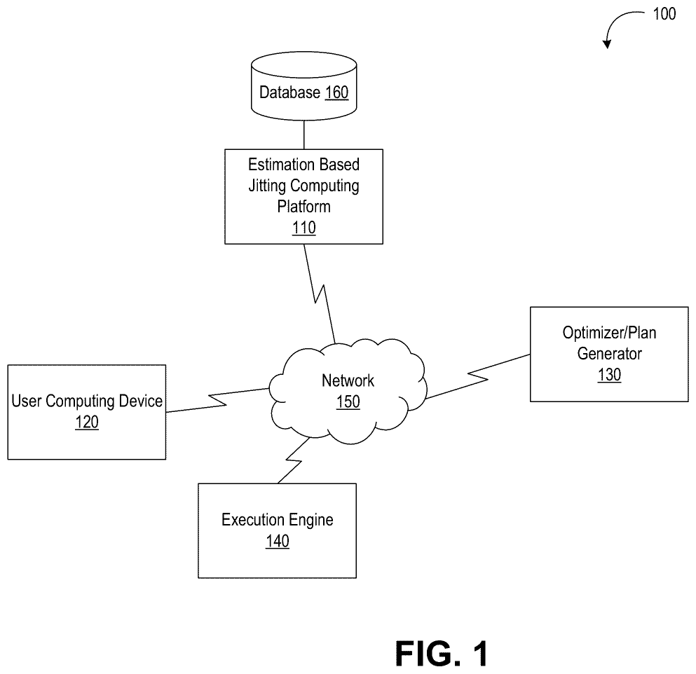

FIG. 1 depicts an illustrative computing environment 100 for estimation based just-in-time (JIT) compiling in accordance with some example embodiments. Referring to FIG. 1, the computing environment 100 may include one or more computing devices and/or other computing systems. For example, computing environment 100 may include an estimation based jitting computing platform 110, a user computing device 120, a optimizer/plan generator 130, an execution engine 140, and a database 160. Estimation based jitting computing platform 110 may include one or more computing devices configured to perform one or more of the functions described herein. Among other features, estimation based jitting computing platform 110 may determine the highest value between an estimated input cardinality, an estimated output cardinality, and an estimated intermediate cardinality for each operator (the intermediate cardinality being used for join operators (e.g., SQL JOIN)). When the cardinality is below the lower threshold (e.g., representing low workload), estimation based jitting computing platform 110 does not trigger any compilation and the execution commences with the interpreter. After three executions, the compilation is initiated asynchronously, and the compiled code replaces the interpreter as soon as it becomes available. If the cardinality is between the low and medium threshold (e.g., referring to medium workload), estimation based jitting computing platform 110 starts compilation asynchronously during plan generation. If the compiled code is not ready when the execution begins, the interpreter is used. For high workloads (e.g., where the cardinality exceeds the medium threshold), estimation based jitting computing platform 110 triggers compilation and the interpreter is not used. If the compiled code is not ready when an operator starts executing, the operation is blocked and made to wait. In some implementations, query HINTs or runtime compilation enforcers may override this behavior.

User computing device 120 may be a processor-based device including, for example, a smartphone, a tablet computer, a wearable apparatus, a virtual assistant, an Internet-of-Things (IoT) appliance, and/or the like.

Optimizer/plan generator 130 may be implemented by a server. Optimizer/plan generator 130 may produce a query execution plan for executing a query request in a “cost effective” manner. For example, optimizer/plan generator 130 may parse and optimize a request, and generate a query plan for executing the request. Optimizer/plan generator 130 may determine the most optimal execution plan for a structured query language (SQL) statement to access requested data. Once generated, optimizer/plan generator 130 passes the query plan to execution engine 140. Execution engine 140 processes the query plan. Additionally, optimizer/plan generator 130 may include an estimator for determining or calculating cardinality estimates, including estimating the size of intermediate results. In some examples, optimizer/plan generator 130 may provide a cardinality estimate for determining whether to compile code.

The execution engine 140 may be and/or include a just-in-time (JIT) compiler. The execution engine 140 processes SQL queries. The source code of a programming language may be executed using an interpreter or a compiler. A compiler may translate code from a high-level programming language (e.g., human-readable code) into machine code (e.g., computer-readable machine code) before the program runs. An interpreter may translate code written in a high-level programming language into machine code line-by-line as the code runs. Compiled code runs faster (e.g., taking minutes or seconds for execution), while interpreted code runs slower (e.g., taking hours or days for execution). However, because a compiler takes in the entire program, latency is introduced. The interpreter takes in a single line of code and therefore less time is needed to analyze the code. In some example embodiments, a separate parser or translator may perform the above described parsing and translating steps. In some example embodiments, the estimation based jitting computing platform 110 may be part of the execution engine 140.

The compiler mode and the interpreter mode may be traded off depending on the data. An optimal decision may be based on, for example, a number of work units for a query (e.g., steps to process data) or absolute times for compilation (e.g., per work unit for compilation/interpretation). In some instances, the optimal decision may be based on a number of times that a query is executed (e.g., for ad-hoc queries which are executed once against the database and not again, interpretation would be the optimal choice over compilation).

Referring again to FIG. 1, the estimation based jitting computing platform 110, the user computing device 120, the optimizer/plan generator 130, the execution engine 140, and the database 160 may be communicatively coupled via a network 150. The network 150 may be a wired and/or wireless network including, for example, a wide area network (WAN), local area network (LAN), a virtual local area network (VLAN), the Internet, and/or the like. Meanwhile, the optimizer/plan generator 130 and/or the execution engine 140 may be cloud-based systems hosted on one or more cloud-computing platforms. Database 160 may include, for example, a relational database, an in-memory database, a graph database, a key-value store, a document store, and/or the like. In some examples, the estimation based jitting computing platform 110 may maintain (e.g., store) various types of data, including static and nonstatic data (e.g., system data, customizing data, master data, application data, log data, and/or the like) in one or more database tables at a database 160 coupled with the estimation based jitting computing platform 110.

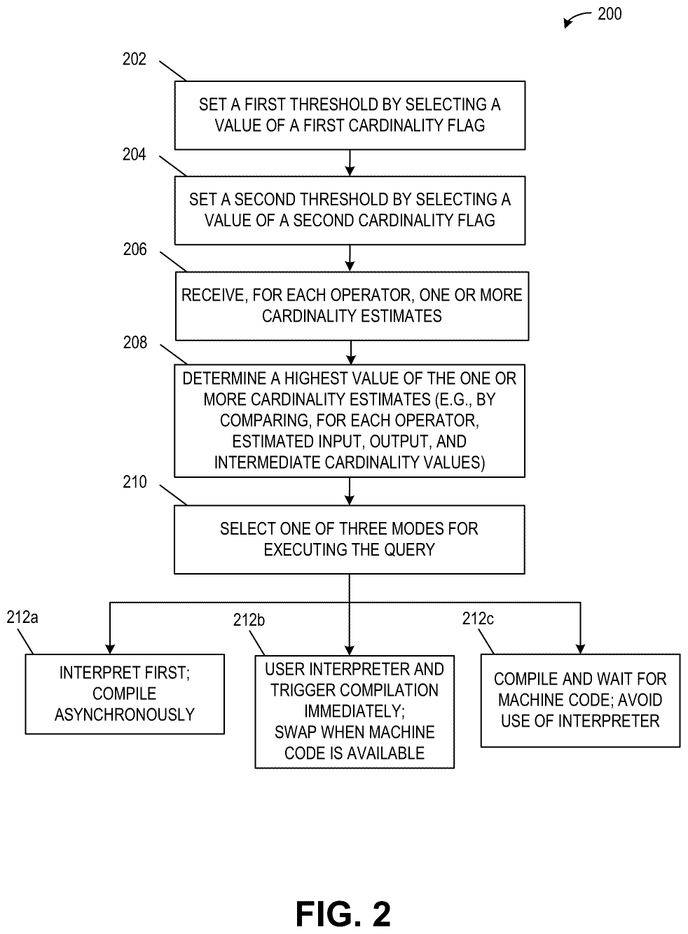

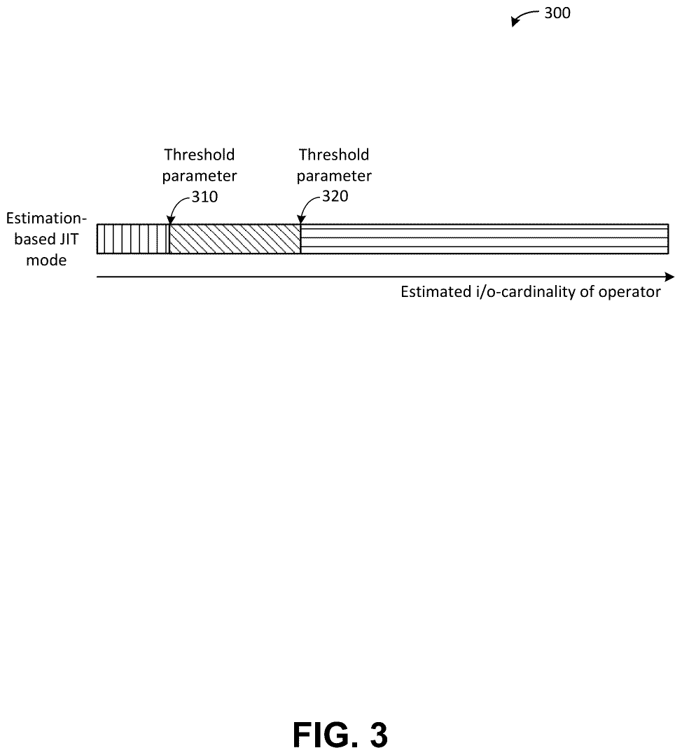

FIGS. 2 and 3 will be discussed together. FIG. 2 depicts a flowchart 200 illustrating a process for estimation based just-in-time compiling, in accordance with some example embodiments. FIG. 3 depicts a block flow diagram 300 illustrating a process for estimation based just-in-time compiling in accordance with some example embodiments, with reference to the steps in FIG. 2.

As will be appreciated, aspects, embodiments, and/or configurations of the disclosure allows for interpreters to be used for queries with low estimated cardinalities, leading to lower latency for non-complex queries or for those that only have short run times. On the other hand, long-running queries and those handling a significant amount of data may be compiled directly.

Referring to FIG. 2, in an estimation-based mode, at step 202, estimation based jitting computing platform 110 may set, from a user interface, a first threshold by selecting a value of a first cardinality flag (e.g., “max_cardinality_flag_low_workload” to set a lower threshold). At step 204, estimation based jitting computing platform 110 may set, from the user interface, a second threshold by selecting a value of a second cardinality flag (e.g., “max_cardinality_flag_medium_workload” to set a medium threshold), the second threshold being greater than the first threshold. The first threshold and the second threshold may be set at a tenant database level. In some examples, the first threshold and the second threshold may be set based on empirical data or benchmark data associated with a workload (e.g., a value of 5 for low workload threshold and a value of 10,000 for medium workload threshold). In this respect, FIG. 3 illustrates a first threshold parameter 310 and a second threshold parameter 320. Based on the cardinality level, a different compilation strategy or processing mode may be applied. In some examples, the thresholds 310 and 320, may be determined using empirical data or benchmarks. Additionally or alternatively, the thresholds may be fine-tuned by a user or via machine learning.

Returning to FIG. 2, at step 206, estimation based jitting computing platform 110 may receive, from an optimizer (e.g., optimizer/plan generator 130), one or more cardinality estimates for each operator of a query. The one or more cardinality estimates may include one or more of: an estimated input cardinality, an estimated output cardinality, and an estimated intermediate cardinality. The estimated intermediate cardinality may provide an estimate indicating a number of result tuples of a join operator.

At step 208, estimation based jitting computing platform 110 may determine a highest value of the one or more cardinality estimates for each operator of the query. For example, estimation based jitting computing platform 110 may compare, for each operator, values of an estimated input cardinality, an estimated output cardinality, and an estimated intermediate cardinality, and determine a highest value between them.

At step 210, estimation based jitting computing platform 110 may select, based on the highest value of the one or more cardinality estimates for each operator of the query, one of at least three processing modes for processing the query. For example, the at least three processing modes may include a first mode, a second mode, and a third mode.

With respect to the first mode, at step 212a, based on the highest value being below (e.g., less than) or equal to the first threshold (e.g., “low” cardinality), estimation based jitting computing platform 110 may commence processing of the query by interpreting source code and initiate compiling of the source code asynchronously. For example, after executing the interpreting a predetermined number of times (e.g., three times), estimation based jitting computing platform 110 may initiate the compiling and switch the processing to compiled code. Such a compilation strategy may be used for low effort queries with few data points.

With respect to the second mode, at step 212b, based on the highest value being between the first threshold and the second threshold (e.g., “medium” cardinality), estimation based jitting computing platform 110 may commence processing of the query by both compiling and interpreting the source code. In addition, machine code may be swapped when available. The second mode offers a mechanism for medium cardinality queries where classification is not straightforward. In these cases, compilation is triggered, but the execution swiftly switches to compiled code when the compiled code is available. Since estimations could be off or inaccurate, in the second mode, because the compilation process is also started, the compiled result would be available as soon as possible. Thereby, if at runtime, a decision is made to run native code, the compilation would have been already triggered, reducing wait time.

With respect to the third mode, at step 212c, based on the highest value being above (e.g., greater than) or equal to the second threshold (e.g., “high” cardinality), estimation based jitting computing platform 110 may commence processing of the query by compiling the source code and avoiding use of an interpreter.

The estimation-based mode described herein provides a more granular execution strategy, deciding on a per-operator basis, guided by estimated cardinalities. By selecting the most appropriate execution strategy (e.g., compiling or interpreting), the system may achieve optimal performance for specific workloads. Advantageously, by tailoring the thresholds, the system may dynamically adjust, leveraging the best of both compiled and interpreted processing modes.

Additionally, or alternatively, in some examples, estimation based jitting computing platform 110 may override the selected processing mode by triggering compilation earlier than specified by the selected processing mode. For example, a runtime compilation enforcer may trigger compilation earlier if, at runtime, a large workload is identified (e.g., at a pipeline breaker (including a JOIN, subquery, or ORDER BY operator) which materializes an intermediate result and cannot produce an output until it has processed every record). In some aspects, a pipeline breaker can refer to an operator that takes an incoming tuple out of a storage location (e.g., a portion of memory and/or a CPU register) for a given input side and/or materializes at least a portion of (e.g., all) incoming tuples from the input side before continuing processing. After accumulating the intermediate result, the number of tuples may be identified.

In some implementations, predefined and user-defined hints may be used to influence the processing of SQL queries. Hints may include instructions for a database server which may influence the way a database request is processed. For example, an SQL optimizer may determine an access path of a query, but a user may override the optimizer by specifying hints in the query to enforce a certain access path. In some cases, schema-specific hints may override the behavior of the estimation-based JIT mode. Thus, in some embodiments, hints related to compilation modes may be disabled or deactivated.

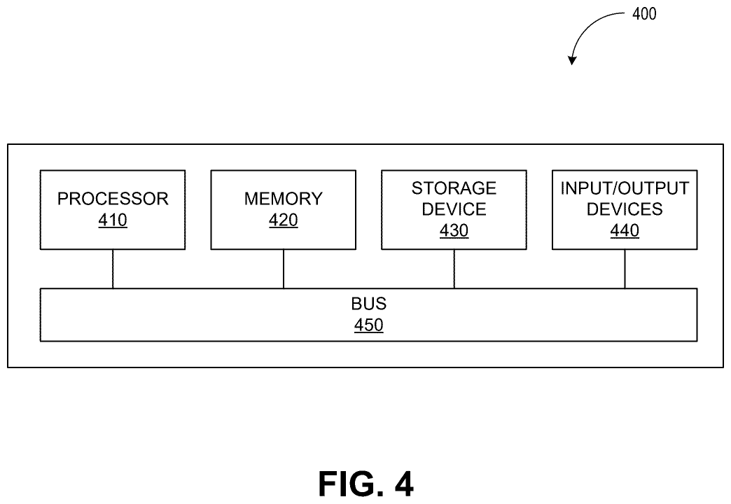

FIG. 4 depicts a block diagram illustrating a computing system 400 consistent with implementations of the current subject matter. Referring to FIGS. 1-4, the computing system 400 can be used to implement the estimation based jitting computing platform 110 and/or any components therein.

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The processor 410 is capable of processing instructions for execution within the computing system 400. Such executed instructions can implement one or more components of, for example, the estimation based jitting computing platform 110. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a solid-state device, a floppy disk device, a hard disk device, an optical disk device, a tape device, and/or any other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and
at least one memory storing instructions, which when executed by the at least one processor, result in operations comprising:
   setting, from a user interface, a first threshold by selecting a value of a first cardinality flag;
   setting, from the user interface, a second threshold by selecting a value of a second cardinality flag, the second threshold being greater than the first threshold;
   receiving, from an optimizer, one or more cardinality estimates for each operator of a query;
   determining a highest value of the one or more cardinality estimates for each operator of the query;
   selecting, based on the highest value of the one or more cardinality estimates for each operator of the query, one of at least three processing modes for processing the query, wherein the at least three processing modes comprises: a first mode, a second mode, and a third mode;
   based on the highest value being less than or equal to the first threshold, indicating the first mode, commencing processing of the query by interpreting source code and initiating compiling of the source code asynchronously;
   based on the highest value being between the first threshold and the second threshold, indicating the second mode, commencing processing of the query by both compiling and interpreting the source code; and
   based on the highest value being greater than or equal to the second threshold, indicating the third mode, commencing processing of the query by compiling the source code and avoiding use of an interpreter.

Example 2: The system of Example 1, wherein the one or more cardinality estimates comprises one or more of: an estimated input cardinality, an estimated output cardinality, and an estimated intermediate cardinality.

Example 3: The system of any of Examples 1-2, wherein initiating compiling of the source code asynchronously comprises: initiating the compiling after executing the interpreting a predetermined number of times; and switching the processing to compiled code.

Example 4: The system of any of Examples 1-3, further comprising: in the second mode, switching the processing to compiled code when the compiled code is available.

Example 5: The system of any of Examples 1-4, further comprising: overriding the selected processing mode by triggering compilation earlier than specified by the selected processing mode.

Example 6: The system of any of Examples 1-5, wherein the first threshold and the second threshold are based on benchmark data associated with a workload.

Example 7: The system of any of Examples 1-6, wherein the first threshold and the second threshold are set at a tenant database level.

Example 8: The system of any of Examples 1-2, wherein the estimated intermediate cardinality comprises an estimate indicating a number of result tuples of a join operator.

Example 9: A computer-implemented method comprising:
setting, from a user interface, a first threshold by selecting a value of a first cardinality flag;
setting, from the user interface, a second threshold by selecting a value of a second cardinality flag, the second threshold being greater than the first threshold;
receiving, from an optimizer, one or more cardinality estimates for each operator of a query;
determining a highest value of the one or more cardinality estimates for each operator of the query;
selecting, based on the highest value of the one or more cardinality estimates for each operator of the query, one of at least three processing modes for processing the query, wherein the at least three processing modes comprises: a first mode, a second mode, and a third mode;
based on the highest value being less than or equal to the first threshold, indicating the first mode, commencing processing of the query by interpreting source code and initiating compiling of the source code asynchronously;
based on the highest value being between the first threshold and the second threshold, indicating the second mode, commencing processing of the query by both compiling and interpreting the source code; and
based on the highest value being greater than or equal to the second threshold, indicating the third mode, commencing processing of the query by compiling the source code and avoiding use of an interpreter.

Example 10: The computer-implemented method of Example 9, wherein the one or more cardinality estimates comprises one or more of: an estimated input cardinality, an estimated output cardinality, and an estimated intermediate cardinality.

Example 11: The computer-implemented method of any of Examples 9-10, wherein initiating compiling of the source code asynchronously comprises: initiating the compiling after executing the interpreting a predetermined number of times; and switching the processing to compiled code.

Example 12: The computer-implemented method of any of Examples 9-11, further comprising: in the second mode, switching the processing to compiled code when the compiled code is available.

Example 13: The computer-implemented method of any of Examples 9-12, further comprising: overriding the selected processing mode by triggering compilation earlier than specified by the selected processing mode.

Example 14: The computer-implemented method of any of Examples 9-13, wherein the first threshold and the second threshold are based on benchmark data associated with a workload.

Example 15: The computer-implemented method of any of Examples 9-14, wherein the first threshold and the second threshold are set at a tenant database level.

Example 16: The computer-implemented method of any of Examples 9-10, wherein the estimated intermediate cardinality comprises an estimate indicating a number of result tuples of a join operator.

Example 17: A non-transitory computer readable medium storing instructions, which when executed by at least one processor, result in operations comprising:
setting, from a user interface, a first threshold by selecting a value of a first cardinality flag;
setting, from the user interface, a second threshold by selecting a value of a second cardinality flag, the second threshold being greater than the first threshold;
receiving, from an optimizer, one or more cardinality estimates for each operator of a query;
determining a highest value of the one or more cardinality estimates for each operator of the query;
selecting, based on the highest value of the one or more cardinality estimates for each operator of the query, one of at least three processing modes for processing the query, wherein the at least three processing modes comprises: a first mode, a second mode, and a third mode;
based on the highest value being less than or equal to the first threshold, indicating the first mode, commencing processing of the query by interpreting source code and initiating compiling of the source code asynchronously;
based on the highest value being between the first threshold and the second threshold, indicating the second mode, commencing processing of the query by both compiling and interpreting the source code; and
based on the highest value being greater than or equal to the second threshold, indicating the third mode, commencing processing of the query by compiling the source code and avoiding use of an interpreter.

Example 18: The non-transitory computer-readable medium of Example 17, wherein the one or more cardinality estimates comprises one or more of: an estimated input cardinality, an estimated output cardinality, and an estimated intermediate cardinality.

Example 19: The non-transitory computer-readable medium any of Examples 17-18, wherein initiating compiling of the source code asynchronously comprises: initiating the compiling after executing the interpreting a predetermined number of times; and switching the processing to compiled code.

Example 20: The non-transitory computer-readable medium any of Examples 17-19, in the second mode, switching the processing to compiled code when the compiled code is available.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory storing instructions, which when executed by the at least one processor, result in operations comprising:
setting, from a user interface, a first threshold by selecting a value of a first cardinality flag;
setting, from the user interface, a second threshold by selecting a value of a second cardinality flag, the second threshold being greater than the first threshold;
receiving, from an optimizer, one or more cardinality estimates for each operator of a query;
determining a highest value of the one or more cardinality estimates for each operator of the query;
selecting, based on the highest value of the one or more cardinality estimates for each operator of the query, one of at least three processing modes for processing the query, wherein the at least three processing modes comprises: a first mode, a second mode, and a third mode;
based on the highest value being less than or equal to the first threshold, indicating the first mode, commencing processing of the query by interpreting source code and initiating compiling of the source code asynchronously;
based on the highest value being between the first threshold and the second threshold, indicating the second mode, commencing processing of the query by both compiling and interpreting the source code; and
based on the highest value being greater than or equal to the second threshold, indicating the third mode, commencing processing of the query by compiling the source code and avoiding use of an interpreter.

2. The system of claim 1, wherein the one or more cardinality estimates comprises one or more of: an estimated input cardinality, an estimated output cardinality, and an estimated intermediate cardinality.

3. The system of claim 1, wherein initiating compiling of the source code asynchronously comprises:
initiating the compiling after executing the interpreting a predetermined number of times; and
switching the processing to compiled code.

4. The system of claim 1, further comprising: in the second mode, switching the processing to compiled code when the compiled code is available.

5. The system of claim 1, further comprising: overriding the selected processing mode by triggering compilation earlier than specified by the selected processing mode.

6. The system of claim 1, wherein the first threshold and the second threshold are based on benchmark data associated with a workload.

7. The system of claim 1, wherein the first threshold and the second threshold are set at a tenant database level.

8. The system of claim 2, wherein the estimated intermediate cardinality comprises an estimate indicating a number of result tuples of a join operator.

9. A computer-implemented method comprising:
setting, from a user interface, a first threshold by selecting a value of a first cardinality flag;
setting, from the user interface, a second threshold by selecting a value of a second cardinality flag, the second threshold being greater than the first threshold;
receiving, from an optimizer, one or more cardinality estimates for each operator of a query;
determining a highest value of the one or more cardinality estimates for each operator of the query;
selecting, based on the highest value of the one or more cardinality estimates for each operator of the query, one of at least three processing modes for processing the query, wherein the at least three processing modes comprises: a first mode, a second mode, and a third mode;
based on the highest value being less than or equal to the first threshold, indicating the first mode, commencing processing of the query by interpreting source code and initiating compiling of the source code asynchronously;
based on the highest value being between the first threshold and the second threshold, indicating the second mode, commencing processing of the query by both compiling and interpreting the source code; and
based on the highest value being greater than or equal to the second threshold, indicating the third mode, commencing processing of the query by compiling the source code and avoiding use of an interpreter.

10. The computer-implemented method of claim 9, wherein the one or more cardinality estimates comprises one or more of: an estimated input cardinality, an estimated output cardinality, and an estimated intermediate cardinality.

11. The computer-implemented method of claim 9, wherein initiating compiling of the source code asynchronously comprises:
initiating the compiling after executing the interpreting a predetermined number of times; and
switching the processing to compiled code.

12. The computer-implemented method of claim 9, further comprising: in the second mode, switching the processing to compiled code when the compiled code is available.

13. The computer-implemented method of claim 9, further comprising: overriding the selected processing mode by triggering compilation earlier than specified by the selected processing mode.

14. The computer-implemented method of claim 9, wherein the first threshold and the second threshold are based on benchmark data associated with a workload.

15. The computer-implemented method of claim 9, wherein the first threshold and the second threshold are set at a tenant database level.

16. The computer-implemented method of claim 10, wherein the estimated intermediate cardinality comprises an estimate indicating a number of result tuples of a join operator.

17. A non-transitory computer readable medium storing instructions, which when executed by at least one processor, result in operations comprising:
setting, from a user interface, a first threshold by selecting a value of a first cardinality flag;
setting, from the user interface, a second threshold by selecting a value of a second cardinality flag, the second threshold being greater than the first threshold;
receiving, from an optimizer, one or more cardinality estimates for each operator of a query;
determining a highest value of the one or more cardinality estimates for each operator of the query;
selecting, based on the highest value of the one or more cardinality estimates for each operator of the query, one of at least three processing modes for processing the query, wherein the at least three processing modes comprises: a first mode, a second mode, and a third mode;
based on the highest value being less than or equal to the first threshold, indicating the first mode, commencing processing of the query by interpreting source code and initiating compiling of the source code asynchronously;
based on the highest value being between the first threshold and the second threshold, indicating the second mode, commencing processing of the query by both compiling and interpreting the source code; and
based on the highest value being greater than or equal to the second threshold, indicating the third mode, commencing processing of the query by compiling the source code and avoiding use of an interpreter.

18. The non-transitory computer readable medium of claim 17, wherein the one or more cardinality estimates comprises one or more of: an estimated input cardinality, an estimated output cardinality, and an estimated intermediate cardinality.

19. The non-transitory computer readable medium of claim 17, wherein initiating compiling of the source code asynchronously comprises:
initiating the compiling after executing the interpreting a predetermined number of times; and
switching the processing to compiled code.

20. The non-transitory computer readable medium of claim 17, further comprising: in the second mode, switching the processing to compiled code when the compiled code is available.
